(19) United States
(12) Patent Application Publication
(10) Pub. No.: US 2013/0236193 A1
(43) Pub. Date: Sep. 12, 2013

(54) Optical Communications Systems that Couple Optical Signals from a Large Core Fiber to a Smaller Core Fiber and Related Methods and Apparatus

(71) Applicant: Abhijit Sengupta, Alpharetta, GA (US)

(72) Inventor: Abhijit Sengupta, Alpharetta, GA (US)

(73) Assignee: CommScope, Inc. of North Carolina, Hickory, NC (US)

(21) Appl. No.: 13/594,908

(22) Filed: Aug. 27, 2012

Related U.S. Application Data
(60) Provisional application No. 61/651,771, filed on May 25, 2012.
(60) Provisional application No. 61/608,891, filed on Mar. 9, 2012.

(51) Int. Cl. H04B 10/13

(52) U.S. Cl. 398/143; 398/200

(57) ABSTRACT

Fiber optic communications systems are provided that include an optical transmission source that is configured to transmit an optical signal having a first wavelength onto a multi-mode optical transmission path, an optical mode field converter that is optically coupled to the multi-mode optical transmission path, and an optical transmission medium that is optically coupled to the optical mode field converter. The multi-mode optical transmission path has a first cross-sectional area and the optical transmission medium has a second cross-sectional area that is smaller than the first cross-sectional area. The optical transmission medium is a few-mode transmission medium for the optical signal having the first wavelength.

### CROSS REFERENCE TO RELATED APPLICATIONS

This application claims priority under 35 U.S.C. §119 to U.S. Provisional Patent Application No. 61/608,891, filed Mar. 9, 2012 and to U.S. Provisional Application No. 61/651,771, filed May 25, 2012, the disclosure of each of which is hereby incorporated herein by reference.

### BACKGROUND

The present disclosure relates generally to fiber optic communications systems and, more particularly, to systems and apparatus that are capable of coupling an optical signal onto an optical fiber or other medium.

When an optical signal is transmitted over an optical fiber, the optical fiber may support one or a plurality of propagation modes, depending upon the wavelength of the optical signal and the size (e.g., diameter) of the core of the optical fiber. Generally speaking, for a specified wavelength optical signal, the number of propagation modes that the optical fiber supports increases with increases in the size of the core of the optical fiber. An optical fiber that supports a single propagation mode for a specified wavelength optical signal is referred to as a “single-mode optical fiber.” An optical fiber that supports no more than a small number of propagation modes (e.g., 2-5) for an optical signal at a specified wavelength is often referred to as a “few-mode optical fiber.” For purposes of this application, the term “few-mode optical fiber” refers to an optical fiber that supports five or fewer propagation modes for a specified wavelength, and specifically encompasses single-mode optical fibers. Similarly, the term “multi-mode optical fiber” refers to an optical fiber that supports more than five propagation modes for a specified wavelength. Multi-mode optical fibers often support tens or hundreds of propagation modes. The number of propagation modes that are supported by a particular optical fiber depends on the wavelength of the optical signal that is transmitted over the optical fiber, and thus an optical fiber may operate as a single-mode optical fiber at some wavelengths and as a few-mode optical fiber at other wavelengths. A parameter known as the “cut-off wavelength” specifies the wavelength for a particular optical fiber at which the fiber will change from operating as a single-mode optical fiber to a few-mode optical fiber that supports at least two propagation modes. Since optical fibers are typically designed to carry optical signals at a particular wavelength, optical fibers are often referred to generically as “multi-mode optical fibers” or as “single-mode optical fibers” without reference to a particular optical signal wavelength, as the wavelength is implied by the intended use of the optical fiber. By way of example, the optical transmitter(s) that are attached to an optical fiber will typically be designed to transmit optical signals at a single wavelength or over a narrow wavelength range, and hence these optical transmitter(s) define the wavelength that allows one to determine the number of propagation modes that are supported by the optical fiber.

Vertical-cavity surface-emitting lasers (“VCSELs”) are a type of laser that may be used to generate and transmit optical signals over optical fibers. VCSELs that are widely used for transmitting optical signals over multi-mode optical fibers are typically referred to as “multi-mode VCSELs.” VCSELs can be coupled directly to a multi-mode optical fiber and thus reduce the cost of high data rate optical communications for short range applications such as many enterprise applications. Coupling losses and/or the cost of alignment optics generally make it disadvantageous to use single-mode optical fibers for many short range applications, even though single-mode optical fibers are less expensive than multi-mode optical fibers.

Multi-mode VCSELs are typically designed to transmit optical signals at wavelengths of about 850 nm, which is the wavelength that is typically used for multi-mode optical communications. Multi-mode VCSELs and multi-mode optical fibers are typically used for short distance communications (e.g., 600 meters or less) in “enterprise” applications such as communications within office buildings or within a campus, because of the cost advantages associated with the use of multi-mode VCSELs and because the large core diameter of multi-mode optical fibers simplifies connections. Typically, these VCSEL-driven multi-mode optical links are used to transmit signals at data rates of 10 Gigabits/second (“Gbps”) or higher.

An important characteristic of an optical fiber is the distance over which the fiber can support a given data rate level or bandwidth. Unfortunately, multi-mode optical signals suffer from a spreading of the optical pulse which is referred to as “modal dispersion” or differential mode delay (“DMD”) that result from the propagation of many different modes through the fiber. As modal dispersion builds up very quickly (e.g., within a few hundred meters in multi-mode optical fibers), it effectively limits the use of multi-mode optical transmissions to relatively short distances (e.g., to distances of 600 meters or less for typical optical data rate requirements). Accordingly, single mode optical fibers are typically used for longer distance communications (and are typically transmitted at around 1310 nm or around 1550 nm), but may require the use of more expensive transceivers, alignment optics and other equipment. The current industry trend is to support increasing data rate (bandwidth) demands by reducing the lengths of the multi-mode optical fiber links. However, in larger enterprise installations such as campuses, data centers, large office buildings and the like, these restrictions on the lengths of the optical fiber links may make it more difficult and/or expensive to use multi-mode optical fibers in some situations, or even preclude the use of such multi-mode optical fiber links.

### SUMMARY

Pursuant to embodiments of the present invention, fiber optic communications systems are provided that include an optical transmitter that has an optical transmission source. The optical transmission source is configured to transmit an optical signal having a first wavelength onto an optical transmission path, where the transmission path has a first cross-sectional area and is a multi-mode optical transmission path at the first wavelength. These communications systems also include an optical mode field converter that is optically coupled to the optical transmission path and a fiber optic transmission medium that is optically coupled to the optical mode field converter. The fiber optic transmission medium may have a second cross-sectional area that is smaller than the first cross-sectional area, and the fiber optic transmission medium may be a few-mode transmission medium for an optical signal that has the first wavelength.

In some embodiments, the optical transmission source may be a vertical-cavity-surface-emitting laser. In such embodiments, the fiber optic transmission medium may be a first optical fiber that is a few-mode optical fiber or a single-mode optical fiber for the optical signal having the first wavelength. The fiber optic communications system may also include a second optical fiber that is a multi-mode optical fiber for the optical signal having the first wavelength, where the multi-mode optical fiber is optically coupled between the optical transmitter and the optical mode field converter.

In some embodiments, the first wavelength may be within the range of about 600 nm to about 1550 nm. Moreover, an optical receiver may be optically coupled to the few-mode optical fiber. The system may also include a second optical mode field converter that is optically coupled between the few-mode optical fiber and the optical receiver and, in some cases, may further include a third optical mode field converter that is optically coupled between the second optical mode field converter and the optical receiver. In such embodiments, the few-mode optical fiber and at least one of the first and second optical mode field converters may be an integral structure.

Pursuant to further embodiments of the present invention, methods of optically transmitting data are provided in which an optical signal having a first wavelength is coupled as a multi-mode optical signal to an optical mode field converter. The optical mode field converter is used to convert the multi-mode optical signal into a few-mode optical signal. Finally, the few-mode optical signal is coupled onto an optical fiber that acts as a few-mode optical fiber when carrying signals having the first wavelength.

In some embodiments, the optical signal may be an 850 nm optical signal, and a vertical-cavity-surface-emitting laser may be used as an optical transmitter to provide the optical signal having the first wavelength. The method may further include coupling the multi-mode optical signal from the optical transmitter before coupling the multi-mode optical signal to the optical mode field converter. The few-mode optical signal may also be coupled from the few-mode optical fiber to an optical receiver. In some embodiments, this may be done by, for example, coupling the few-mode optical signal from the few-mode optical fiber to a second optical mode field converter that converts the few-mode optical signal into a second multi-mode optical signal, and then couples the second multi-mode optical signal from the second optical mode field converter to the optical receiver.

Pursuant to still further embodiments of the present invention, methods of transmitting an optical signal through an optical connector are provided in which the optical signal is transmitted as a first few-mode optical signal along an optical transmission medium. The first few-mode optical signal is converted to a multi-mode optical signal, and then the multi-mode optical signal is transmitted through the optical connector. Finally, the multi-mode optical signal may be converted into a second few-mode optical signal.

In some embodiments, a first optical mode field converter may be used to convert the first few-mode optical signal to the multi-mode optical signal, and a second optical mode field converter may be used to convert the multi-mode optical signal into the second few-mode optical signal. In some cases, the first optical mode field converter and the second optical mode field converter may each be directly connected to the optical connector. The optical signal may have a first wavelength of, for example, about 600 nm or of about 1550 nm.

Pursuant to still further embodiments of the present invention, optical cables are provided that include a cable jacket, a first optical fiber having a first end and a second end in the cable jacket, at least one strength member in the cable jacket, a first optical mode field converter, and a first housing that mounts the first optical mode field converter in longitudinal alignment with the first end of the first optical fiber. In some embodiments, these optical cables may further include a second optical mode field converter and a second housing that mounts the second optical mode field converter in longitudinal alignment with the second end of the first optical fiber. The first optical fiber may be, for example, a few-mode optical fiber for an optical signal having a wavelength of 850 nm, and an output of the first optical mode field converter that is opposite the first end of the first optical fiber may be configured to output the optical signal having the wavelength of 850 nm as a multi-mode optical signal. The first optical mode field converter may be a silicon photonic-based optical mode field converter such as, for example, a tapered waveguide, a photonic crystal or a grating coupler.

Pursuant to still further embodiments of the present invention, optical communications systems are provided that include a linear array of optical fibers, a photonic crystal waveguide that is coupled to the linear array of optical fibers, a silicon photonic integrated circuit chip that includes a plurality of optical mode field converters that are optically coupled to the linear array of optical fibers, and a multi-core optical fiber having a plurality of cores, where each core is optically coupled to a respective one of the plurality of optical mode field converters. In some embodiments, the optical communications system may also include a multi-push-on (“MPO”) connector that receives the linear array of optical fibers. A cross-sectional area of a core of each of the optical fibers in the linear array of optical fibers may be at least ten times greater than a cross-sectional area of the respective core of the multi-core fiber to which it is connected via the a silicon photonic integrated circuit chip.

Pursuant to still further embodiments of the present invention, optical receivers are provided that include a housing that has a connector port that is configured to receive an optical cable that includes at least a first optical fiber, an optical mode field converter that is optically coupled to the connector port. The optical mode field converter has a small area light field output and a large area light field input that is optically coupled to the connector port so as to be longitudinally aligned with the first optical fiber of the optical cable. The optical receiver further includes a photo-detector that is optically coupled to the small area light field output of the optical mode field converter. In some embodiments, the optical mode field converter comprises a silicon photonic-based tapered waveguide, photonic crystal or grating coupler. The large area light field input of the optical mode field converter may be sized to support an 850 nm optical signal as a multi-mode optical signal, and the small area light field output of the optical mode field converter may be sized to support an 850 nm optical signal as a few-mode optical signal

Pursuant to yet additional embodiments of the present invention, optical connectors are provided that include a first optical fiber having a first cross-sectional area, a second optical fiber having a second cross-sectional area that is at least ten times smaller than the first cross-sectional area, and a silicon-photonic-based grating coupler that is configured to receive a large area light field that is output from the first optical fiber and to convert this large area light field into a smaller area light field that is input to the second optical fiber.

In some embodiments, the optical connector may also include a mirror that is positioned to reflect the large area light field that is output from the first optical fiber into the silicon photonic-based grating coupler. A portion of the first optical fiber that is proximate the grating coupler may extend longitudinally in a first direction, and a portion of the second optical fiber that is proximate the grating coupler may extend longitudinally in a second direction that is generally parallel to the first direction. The mirror may be a silicon-based mirror that is part of an integrated circuit chip that also includes the grating coupler.

### BRIEF DESCRIPTION OF THE DRAWINGS

FIGS. 1A and 1B are schematic diagrams that illustrate a conventional lens based approach and a conventional tapered waveguide approach, respectively, for reducing a large area light field optical signal to a smaller area light field optical signal.

FIGS. 2A-2E are schematic block diagrams of optical communications systems according to various embodiments of the present invention.

FIG. 3A is a schematic diagram illustrating how a Luneberg lens may be used to implement an optical mode field converter that may be used to optically couple an optical signal from a multi-mode optical fiber to a few-mode optical fiber.

FIG. 3B is a schematic diagram illustrating another way in which a Luneberg lens may be used to implement an optical mode field converter that may be used to optically couple an optical signal from a multi-mode optical fiber to a few-mode optical fiber.

FIG. 3C is a schematic block diagram of a tapered waveguide that may be used to implement an optical mode field converter that may be used in the optical communications systems according to embodiments of the present invention.

FIG. 3D is a schematic block diagram of a holey fiber that may be used to implement an optical mode field converter that may be used in the optical communications systems according to embodiments of the present invention.

FIG. 4A is a schematic block diagram of an optical communication's system according to embodiments of the present invention that includes a silicon photonic grating coupler based optical mode field converter.

FIG. 4B is a schematic diagram of a silicon photonic-based grating coupler.

FIGS. 4C-4E are schematic diagrams of silicon photonic tapered waveguides that may be used in the optical communications systems according to embodiments of the present invention.

FIGS. 4F-4H are schematic diagrams of photonic crystals that may be used in the optical communications systems according to embodiments of the present invention.

FIG. 5 is a schematic block diagram of an optical communications system according to further embodiments of the present invention.

FIG. 6 is a flow chart of a method of optically transmitting data according to certain embodiments of the present invention.

FIG. 7 is a schematic diagram of an optical cable according to certain embodiments of the present invention.

FIG. 8 is a schematic diagram of an optical communications system according to still further embodiments of the present invention.

FIG. 9 is a schematic block diagram of an optical receiver according to certain embodiments of the present invention.

### DETAILED DESCRIPTION

Pursuant to embodiments of the present invention, optical communications systems are provided which employ optical mode field converters to compress a relatively large area light field that is received from, for example, a large core optical fiber such as a multi-mode optical fiber or from an inexpensive multi-mode VCSEL, into a much smaller area light field which may be optically coupled onto a small core optical fiber such as a single mode optical fiber (or a few-mode optical fiber) or to a small area, high-speed photodetector. As the optical communications systems according to embodiments of the present invention may use inexpensive multi-mode VCSELs to transmit optical signals onto few-mode (including single-mode) optical fibers, these systems may support substantially increased data rates and/or substantially longer optical link distances with a significant cost advantage. Moreover, these improvements may be achieved without any changes to the existing enterprise fiber optic apparatus and connectivity solutions.

While conventional lens-based systems may be used to reduce a large area light field to a smaller area light field, these systems typically exhibit high losses and may not practically be used to optically couple the output of a multi-mode VCSEL to a single-mode optical fiber. Optical communications systems according to embodiments of the present invention may solve that problem by using small form factor, low cost, silicon photonic-based optical mode field converters to compress the mode field of a large area light field such as the light field that may be output by a multi-mode VCSEL or a multi-mode optical fiber. These optical mode field converters may be designed to efficiently couple the incident light from a large area light source to a waveguide, and then adiabatically convert the optical mode field to a much smaller area mode field that can be efficiently coupled to a single-mode optical fiber. As will be discussed in more detail herein, in the present application the phrase “silicon photonic” is used herein to encompass both silicon based photonic semiconductor structures (e.g., a structure formed of silicon, silicon nitride and silicon oxide) as well as photonic semiconductor structures that are formed using semiconductors other than silicon.

By way of example, in some embodiments, an optical mode field converter may be used to compress an 850 nm optical signal having a light field with a diameter of on the order of about 50 microns that is received from a multi-mode optical fiber to an 850 nm optical signal having a light field with a diameter on the order of about 5 microns, which signal may be optically coupled onto a single-mode optical fiber. The optical-mode field converters according to embodiments of the present invention may thus be used to increase the effective distances over which optical signals may be transmitted in already-deployed multi-mode optical communications systems by allowing these signals to be transmitted over few-mode optical fibers. It will be appreciated that the optical mode field converters according to embodiments of the present invention may be used to compress optical signals having wavelengths other than 850 nm. By way of example, in other embodiments the optical mode field converters may be used to compress the light fields of optical signals in the 600 nm to 1550 nm wavelength range. It will also be appreciated that embodiments of the present invention may be used in applications other than compressing the output from a multi-mode optical fiber to a single-mode optical fiber, and thus the optical mode field converters according to embodiments of the present invention may be used to compress any appropriate large area light field to a small area light field.

The optical mode field converters according to embodiments of the present invention also may have many additional uses such as, for example, as a method of implementing inexpensive active fiber optic cables that use multi-mode VCSELs and single-mode fibers, for coupling multi-mode optical fibers to small area, high speed photodetectors, for coupling optical signals from a multi-mode MPO connector to single-mode optical fibers and/or for coupling an array of multi-mode optical fibers (e.g., a multi-mode MPO connector) to a single multicore optical fiber or to a single-mode MPO connector within a very small form factor.

The methods, apparatus and systems according to embodiments of the present invention may allow optical communications systems users to extend the life of their existing multi-mode transceivers and other multi-mode apparatus, while at the same time allowing these users to meet future bandwidth requirements without constraining the topology of the optical communications systems. These embodiments of the present invention may add value to existing terminated optical communications systems, create an alternative roadmap for adoption of silicon photonic technology in the enterprise space, and allow the use of few-mode optical fibers to achieve a low cost increase in both bandwidth and reach, thereby increasing the life of the already-installed low cost multi-mode VCSEL based optical communications systems. Additionally, according to further embodiments of the present invention, optical mode field converters may be used to keep the exposed end face of fiber optic cables as large diameter end faces (e.g., optical fibers with 50 micron core diameters), and hence the techniques according to embodiments of the present invention may experience reduced losses due to dust particles as compared to current single-mode optical fiber communications systems. The techniques disclosed herein may also allow for higher level functions (i.e. couplers, dispersion compensators, wave division multiplex (WDM) MUX-DEMUX filters, sensors, etc.) to be integrated in cabling solutions for intelligent applications. It is expected that the optical communications systems according to embodiments of the present invention may provide significant bandwidth, margin and/or range improvement, thus extending the reach of multi-mode communications links to higher data rates (e.g., >10 Gbps).

Exemplary embodiments of the present invention will now be discussed in greater detail with reference to the accompanying drawings.

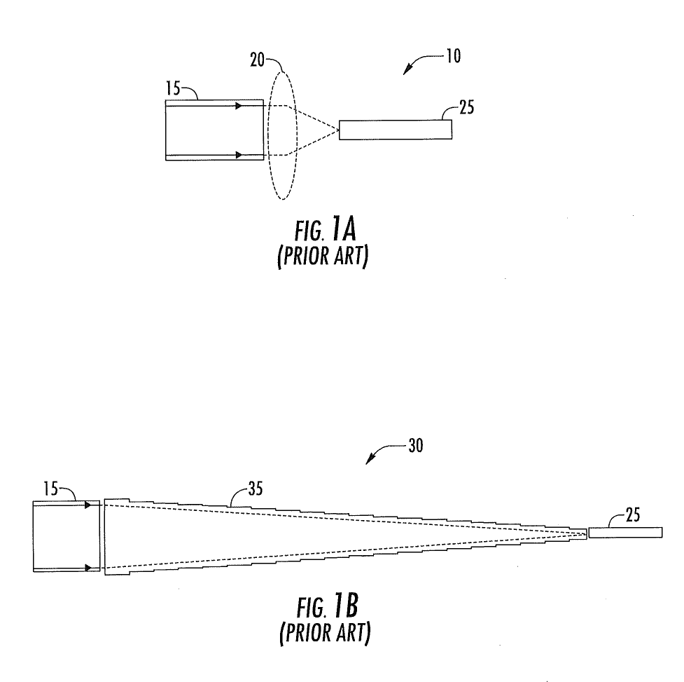

A variety of methods are known for reducing the area of a light field of an optical signal so that the optical signal may be optically coupled onto a component having a smaller cross-sectional area such as a waveguide. FIG. 1A schematically depicts a system 10 that exemplifies one such method. As shown in FIG. 1A, a large area light field that is output from a light source 15 is passed through a lens 20. The lens 20 reduces the large area light field to a small area light field that is coupled onto an optical transmission medium 25. Unfortunately, however, if the system 10 of FIG. 1A is used to optically couple an optical signal from a multi-mode optical fiber 15 to a single-mode optical fiber 25, it may be difficult to accurately align the fibers 15, 25 and the lens 20, and the optical signal will also typically experience high losses when passed to the single-mode optical fiber 25. The system 10 may also be expensive. Because of these disadvantages, single-mode optical fiber communications systems typically use different lasers than multi-mode optical fiber communications systems that produce a more focused optical signal, and then use a lens to further focus the optical signal to facilitate coupling the optical signal directly from the optical transmitter (i.e., the laser) onto the single-mode optical fiber.

FIG. 1B schematically illustrates a system 30 that employs another known method for reducing the area of a light field of an optical signal so that the optical signal may be optically coupled onto a component having a smaller cross-sectional area. As shown in FIG. 1B, with the system 30, a large area light field that is output from the light source 15 is passed through a tapered waveguide 35, which is a waveguide that has a gradually tapered diameter (or other shaped cross-section). The tapered waveguide 35 reduces the large area light field to a small area light field that is coupled onto an optical transmission medium 25. Unfortunately, however, tapered waveguides such as waveguide 35 must typically have a long length if they are to achieve adiabatic mode transformation, and they tend to exhibit poor efficiency when used to reduce the area of the light field of a multi-mode optical signal. Additionally, tapered waveguides do not exhibit good reproducibility, and hence may be impractical for many commercial applications.

As noted above, pursuant to embodiments of the present invention, optical communications systems are provided which employ optical mode field converters to compress a relatively large area light field that is received from, for example, a multi-mode optical fiber or a multi-mode VCSEL that transmit signals in, for example, the 830 nm to 1360 nm range into a much smaller area light field which may be coupled onto a few-mode optical fiber or to a small area, high-speed photodetector. As will be discussed in more detail herein, the optical mode field converters that are used in these optical communications systems may be developed by scaling up or otherwise modifying various techniques that have been proposed for reducing light fields in other applications such as, for example, in coupling single-mode optical fibers to very small waveguides (e.g., waveguides having dimensions of less than a micron). These optical mode field converters may thus be used to optically couple 830 nm to 1360 nm optical signals onto few-mode optical fibers or to small area photodetectors, thereby improving the bandwidth, available margin and/or range of, for example, enterprise optical communications systems.

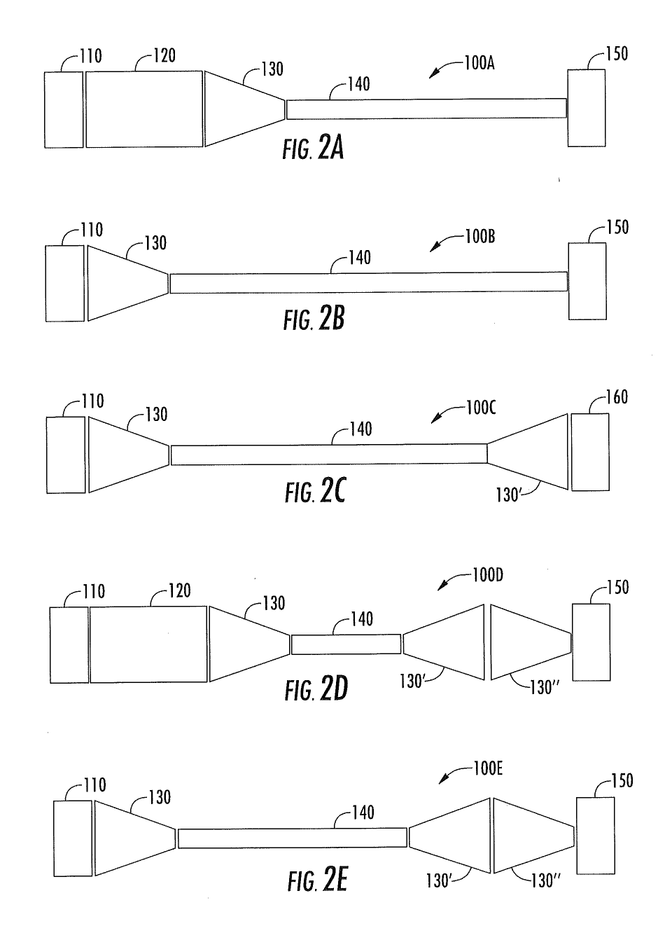

FIGS. 2A-2E are schematic block diagrams of optical communications systems and methods according to embodiments of the present invention.

Turning first to FIG. 2A, this figure illustrates an optical communications system 100A that includes an optical light source 110, a multi-mode optical fiber 120, an optical mode field converter 130, a few-mode optical fiber 140 and a small light field optical receiver 150 (e.g., an optical receiver with a photodetection area that is slightly larger than the cross-sectional area of a single-mode optical fiber). The optical light source 110 may be any optical light source that is suitable for generating an optical signal such as a semiconductor laser or light emitting diode. In some embodiments, the optical light source 110 may comprise an optical transceiver that includes a multi-mode VCSEL that transmits optical signals at certain wavelengths that are within the range of 830 nm to 1360 nm. The optical light source 110 may generate an optical signal that, for example, is suitable for coupling without any lens onto a multi-mode optical fiber. This light field may comprise a large area light field such as, for example, a light field having a diameter of between about 25 microns and about 65 microns.

The optical light source 110 may optically couple the large area light field optical signal to a first end of the multi-mode optical fiber 120. The multi-mode optical fiber 120 may comprise, for example, a conventional optical fiber that is designed for 850 nm optical signals that has a core diameter of between about 25 microns and about 65 microns. Typically, the multi-mode optical fiber 120 will be enclosed within an optical cable structure that may include strength members, buffer tubes, a cable jacket and/or other conventional optical cable components. As these optical cabling components are well-known in the art, they will not be discussed further herein. The other end of the multi-mode optical fiber 120 may be optically coupled to the optical mode field converter 130.

The optical mode field converter 130 may comprise, for example, any of the optical mode field converters according to embodiments of the present invention that are disclosed herein. The optical mode field converter 130 may receive the large area light field output by the multi-mode optical fiber 120, and may then reduce this large area light field to a substantially smaller area light field (e.g., ten to one hundred times smaller).

The optical mode field converter 130 optically couples the small area light field to the few-mode optical fiber 140. The few-mode optical fiber 140 may comprise for example, a conventional single mode optical fiber that is designed for 1310 nm optical signals that has a core diameter of, for example, about 5 microns. Typically, the few-mode optical fiber 140 will be enclosed within an optical cable structure that may include strength members, buffer tubes, a cable jacket and/or other conventional optical cable components. As the optical fiber 140 may be designed to operate as a single-mode optical fiber at 1310 nm and/or at 1550 nm with a cutoff wavelength longer than 850 nm, it may ultimately support a small number of modes (e.g., 2-4 modes) when an 850 nm optical signal is launched into the optical fiber 140. The few-mode optical fiber 140 may optically couple the optical signal that is received from the optical mode field converter 130 to the small light field optical receiver 150. The small light field optical receiver 150 may comprise any conventional optical receiver (or transceiver) that is capable of converting an optical signal to an electrical signal. The optical receiver 150 may have a small area photodetector that is, for example, approximately matched in size to the cross-sectional area of the few-mode optical fiber 140. The use of such a small area photodetector may allow for faster photodetection.

FIG. 2B is a schematic block diagram of an optical communications system 100B according to further embodiments of the present invention. As shown in FIG. 2B, the optical communications system 100B is identical to the optical communications system 100A described above with reference to FIG. 2A, except that the multi-mode optical fiber 120 of optical communications system 100A has been omitted so that the optical light source 110 is optically coupled directly to the optical mode field converter 130. The optical communications system 100B provides a mechanism for directly using multi-mode VCSELs for communications over single-mode optical fibers.

FIG. 2C is a schematic block diagram of an optical communications system 100C according to still further embodiments of the present invention. As shown in FIG. 2C, the optical communications system 100C is identical to the optical communications system 100B described above with reference to FIG. 2B, except that the optical communications system 100C includes a second optical mode field converter 130′, and the small light field optical receiver 150 included in the optical communications system 100A of FIG. 2A is replaced with a large light field optical receiver 160. The large light field optical receiver 160 may comprise, for example an optical receiver (or transceiver) that is designed to receive 850 nm multi-mode optical signals from a multi-mode optical fiber. The second optical mode field converter 130′ that is included in the optical communications system 100C may be used to convert the small area light field that is output by the few-mode optical fiber 140 into a large area light field that is passed to a photodetector in the large light field optical receiver 160. The optical communications system 100C may be implemented, for example, in an already-installed multi-mode optical communications system by simply replacing an existing multi-mode optical fiber with the few-mode optical fiber 140 and the two optical mode field converters 130, 130′.

The second optical mode field converter 130′ may be provided to facilitate reducing the potential negative impact of any dust that may attach to the ends of the few mode optical fiber 140. In particular, optical receivers typically include an optical connector that is used to connect an optical fiber of an optical cable to the optical receiver. As technicians in the field may attach and detach various optical fiber containing cables to and from the optical receiver, there is always a danger that dust particle(s) may come to rest on the end of the optical fiber during one of these operations. A few-mode optical fiber may have a diameter of, for example, about 5 microns. A typical dust particle may have a diameter of, for example, about 1 micron. If one or more dust particles come to rest on the end of a few mode optical fiber, they can potentially block a significant percentage of the light field, thereby degrading the optical communications link.

As shown in the schematic diagram of FIG. 2C, pursuant to embodiments of the present invention, an optical mode field converter 130, 130′ may be, for example, factory installed onto each end of the few-mode optical fiber 140. The optical mode field converter 130 is optically coupled directly to the optical light source 110, and the optical mode field converter 130′ is optically coupled directly to the multi-mode fiber optic receiver 160. When a field technician wishes to change the connectivity to, for example, the optical receiver 160, he may detach the optical mode field converter 130′ of the few-mode optical fiber 140 from the optical receiver 160 and then attach another optical cable having an optical mode field converter that is factory installed thereon into the connector port on the optical receiver 160. The optical mode field converter 130′ may be configured so that it may be directly inserted into the connector port on the optical receiver 160 or, alternatively, a short link of multi-mode optical fiber may be attached to the optical mode field converter 130′ and this multi-mode optical fiber may inserted into the connector port on the multi-mode optical receiver 160. A technician may likewise change the connectivity by detaching optical mode field converter 130 from a connector port on an optical transmitter that includes the optical light source 110, and then attach another optical cable having an optical mode field converter thereon into the connector port on the optical transmitter.

Notably, the fibers/components that are exposed by the field technicians when changing the connections in the manner described above are large area light field components that may have a diameter of, for example, about 50 microns (i.e., the sides of the optical mode field converters 130, 130′ that will be exposed are the sides that pass the large area light field optical signals). As such, the attachment of dust particles to the exposed ends of these optical mode field converters 130, 130′ will typically only block a small percentage of the light field, and hence will have a much smaller degradation effect on the optical signal. Thus, according to embodiments of the present invention, optical mode field converters may be used to reduce the impact that dust particles may have on optical communications systems.

FIG. 2D is a schematic block diagram of an optical communications system 100D according to still further embodiments of the present invention. Like the optical communications system 100C described above, the optical communications system 100D of FIG. 2D may also have reduced susceptibility to dust.

As shown in FIG. 2D, the optical communications system 100D is identical to the optical communications 100A described above with reference to FIG. 2A, except that the optical communications system 100D includes two additional optical mode field converters 130′, 130″. The provision of the second and third optical mode field converters 130′, 130″ allows a technician to only expose components having large area light fields when making connectivity changes. In the optical communications system 100D, the second optical mode field converter 130′ may be factory installed onto the few-mode optical fiber 140 and the third optical mode field converter 130″ may, for example, be integrated in, or factory-attached onto, the single-mode optical receiver 150. Consequently, as the fibers/components that are exposed by the field technicians comprise large area light field components which may have a diameter of, for example, about 50 microns, the attachment of dust particles to the exposed ends of these components/fibers will typically only block a small percentage of the light field, and hence will have a much smaller degradation effect on the optical signal.

FIG. 2E is a schematic block diagram of an optical communications system 100E according to further embodiments of the present invention. As shown in FIG. 2E, the optical communications system 100E is identical to the optical communications system 100D described above with reference to FIG. 2D, except that the multi-mode optical fiber 120 of optical communications system 100D has been omitted so that the optical light source 110 is optically coupled directly to the optical mode field converter 130. The optical communications system 100E provides a mechanism for directly using multi-mode VCSELs for communications over single-mode optical fibers.

While FIGS. 2A-2E illustrate several optical communications system configurations which employ the teachings of the present invention, it will be appreciated that FIGS. 2A-2E are examples, and that the techniques disclosed herein can be used in numerous different configurations in order to achieve the benefits associated with the present invention. Moreover, the elements of the various embodiments of FIGS. 2A-2E may be combined in various ways to obtain additional embodiments.

As shown in FIGS. 2A-2E, embodiments of the present invention may use optical mode field converters to optically couple large area light fields that are output, for example, from multi-mode VCSELs or multi-mode optical fibers onto few-mode optical fibers or into small area photodetectors (e.g., less than 80 square microns) which may exhibit faster detection speeds. By using multi-mode VCSELs to drive few-mode optical fibers, it may be possible to provide low cost fiber optic communication systems that have large bandwidth-distance products. The optical mode field converters that are used in the optical communications systems according to embodiments of the present invention may operate, for example, on optical signals having wavelengths between about 830 nm and about 1360 nm. The optical mode field converters may be designed, for example, to convert a high numerical aperture, large area (e.g., 2000 square microns) light fields to small area light fields that may be coupled at low loss onto a single-mode optical fiber or onto a small area (e.g., 20 square microns) photodetector. Moreover, these optical mode field converters may be easy to align and may exhibit low losses and, in some embodiments, may be low cost units that are suitable for mass production.

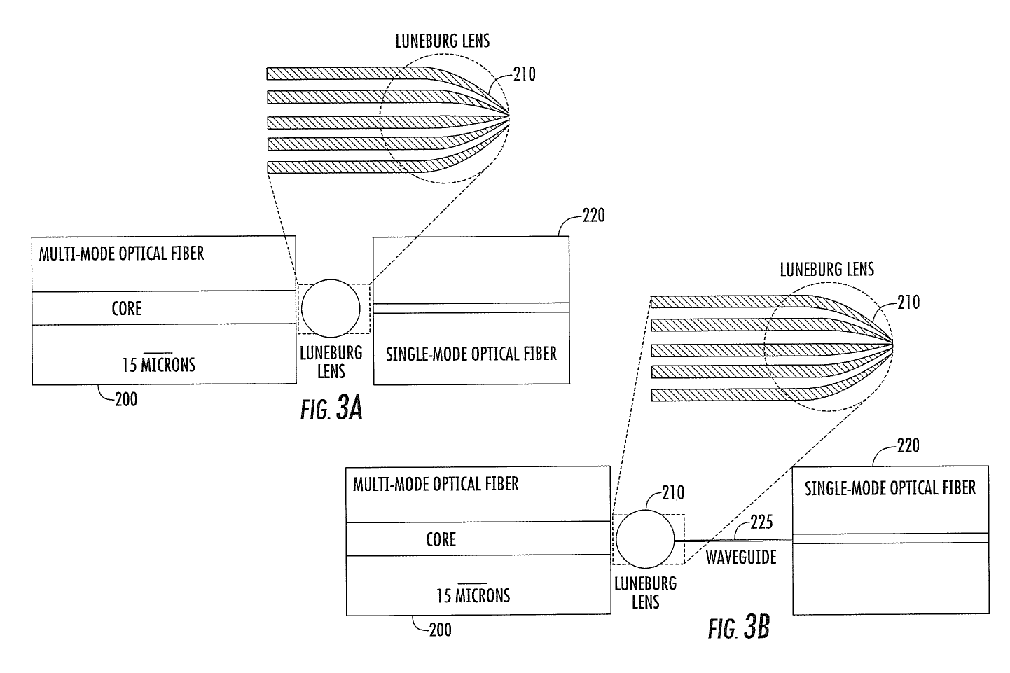

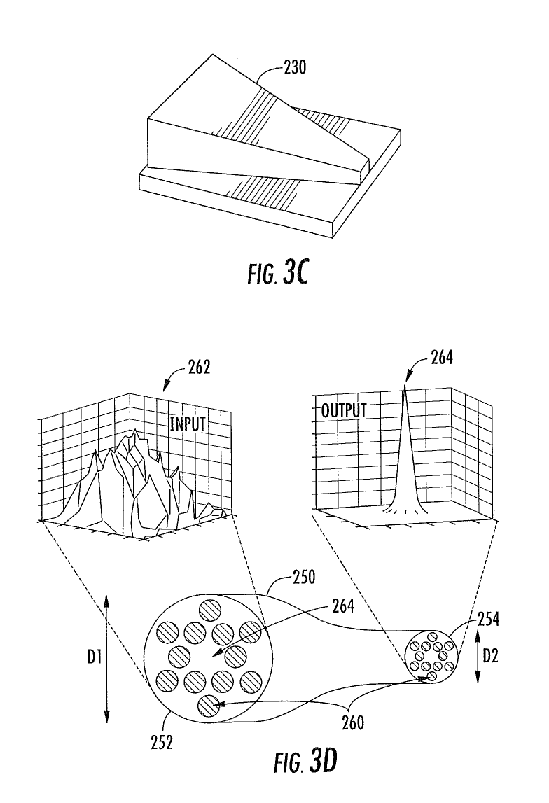

A variety of different technologies may be used to implement the optical mode field converters that are used in embodiments of the present invention. For example, conventional techniques such as tapered waveguides, lenses and/or high index optical fibers or waveguides may be used to implement the optical mode field converters 130, 130′, 130″ in FIGS. 2A-2E. Additionally, a variety of approaches in which optical components are formed on silicon (or other semiconductor) substrates may be used to form the optical mode field converters 130, 130′, 130″ in FIGS. 2A-2E. These semiconductor-based approaches are generally referred to using the phrase “silicon photonic,” and this term is used herein to encompass both silicon based photonic semiconductor structures (e.g., a structure formed of silicon, silicon nitride and silicon oxide) as well as photonic semiconductor structures that use semiconductors other than silicon. Various silicon photonic structures are currently under investigation for coupling 1550 nm optical signals from single-mode optical fibers onto very small area mediums such as silicon waveguides that that have diameters (or lengths and widths) in the hundreds of nanometer range. These silicon photonic approaches include the use silicon-based integrated circuit chips that have tapered waveguides, photonic crystals or grating couplers. Exemplary embodiments of several non-silicon photonic optical mode field converters that may be used in the optical communications systems according to certain embodiments of the present invention are discussed below with reference to FIGS. 3A-D. Exemplary embodiments of several silicon photonic-based optical mode field converters that may be used in the optical communications systems according to certain embodiments of the present invention are discussed below with reference to FIGS. 4A-4H.

FIG. 3A schematically illustrates a lens-based approach for implementing an optical mode field converter that may be used in the optical communications systems according to embodiments of the present invention. As shown in FIG. 3A, a lens 210 structure known as a “Luneberg lens” may be attached or otherwise coupled to the end of a multi-mode optical fiber 200 (or other large area light field optical source). The characteristics and structure of Luneberg lenses are discussed in more detail in an article by L. H. Gabrielli and M. Lipson entitled “Integrated Luneberg Lens via Ultra-Strong Index Gradient on Silicon,” Opt. Exp. 19, p. 20122 (2011), the entire content of which is incorporated herein by reference as if set forth fully herein. As shown in FIG. 3A, the Luneberg lens 210 may bend the large area light field output by the multi-mode optical fiber 200 into a concentrated small area light field. As is also shown in FIG. 3A, in some embodiments, the output of the Luneberg lens 210 may be input to a single mode optical fiber 220. As indicated in FIG. 3A, the Luneberg lens 210 may have a length on the order of tens of microns and hence may readily be coupled to the end of a multi-mode optical fiber without any appreciable increase in the size of the multi-mode optical fiber.

FIG. 3B schematically illustrates another lens-based approach for implementing an optical mode field converter that may be used in the optical communications systems according to embodiments of the present invention that is similar to the approach of FIG. 3A. As shown in FIG. 3B, in a modified approach, a waveguide 225 may be coupled between the Luneberg lens 210 and the single mode optical fiber 220. The waveguide 225 may have an inverse taper that further focuses the light into a smaller area.

FIG. 3C schematically illustrates a tapered waveguide approach that may be used to implement an optical mode field converter that may be included in the optical communications systems according to embodiments of the present invention. As shown in FIG. 3C, a three-dimensional tapered waveguide 230 is provided that reduces a large light field to a much smaller area.

FIG. 3D schematically illustrates a “tapered fiber” approach that may be used to implement the optical mode field converters that may be included in the optical communications systems according to embodiments of the present invention. As shown in FIG. 3D, an adiabatically tapered fiber 250 is provided that includes a plurality of air holes 260 that may be used, for example, to implement the optical mode field converters 130, 130′, 130″ in the optical communications system 100A-E of FIGS. 2A-2E. As shown in FIG. 3D, a first end 252 of the tapered fiber 250 has a first diameter D1 and a second end 254 of the tapered fiber 250 has a second diameter D2 that is substantially smaller than the first diameter D1. The air holes 260 pass longitudinally through the tapered fiber 250, and each air hole gradually tapers so that the air holes 260 have a larger diameter at end 252 and a smaller diameter at the second end 254 of the tapered fiber. The air holes 260 define a “guiding region” 262 that steer the large area light field into a smaller area light field. The tapered fiber 250 may have a very short length such as, for example, a length of 50 microns.

As shown in the callout 262 of FIG. 3D, a large area light field that is incident on the first end 252 of the tapered fiber 250 is compressed to a small area light field (see callout 264) at the second end 254 of the tapered fiber 250. Exemplary tapered fibers that could be adapted to be scaled up for use in embodiments of the present invention are disclosed in, for example, a research paper by G. E. Town and J. T Lizier entitled “Tapered holey fibers for spot size and numerical aperture conversion,” Proc. CLEO Conf. (2011) and in an article by J. D. Love entitled “Spot size, adiabaticity and diffraction in tapered fibers,” Electron. Lett. 23, pp. 993-994 (1987). The entire contents of each of these articles is incorporated herein by reference as if set forth fully herein. In still other embodiments (not depicted in the drawings), high index optical fibers or waveguides may be used to implement the optical mode field converters that are included in optical communications systems according to embodiments of the present invention.

As discussed above, silicon photonic approaches are currently being investigated for purposes of coupling 1550 nm optical signals from single-mode optical fibers onto very small dimension waveguides such as waveguides on integrated circuit chips. According to embodiments of the present invention, various embodiments of this silicon photonic technology may alternatively be used to implement the optical mode field converters that are included in the optical communications systems according to embodiments of the present invention. Typically, the silicon photonic technology will need to be modified to operate at wavelengths in the range of, for example, about 600 nm to about 1550 nm, as the optical mode field converters according to embodiments of the present invention may be designed to receive large area light fields from optical transmitters that include multi-mode VCSELs and/or from multi-mode optical fibers (in each case the transmitters and multi-mode optical fibers may be designed for transmitting optical signals at, for example, 850 nm). In many cases, this may require scaling up the existing silicon photonic component designs by, for example, a factor of ten, so that these components may be used with multi-mode optical fibers and apparatus.

The silicon photonic-based optical mode field converters that may be used in the optical communications systems according to embodiments of the present invention may be fabricated, for example, using standard semiconductor processing techniques. These silicon photonic-based optical mode field converters may include, for example, silicon layers, silicon oxide layers (SiO₂), silicon nitride layers (SiN), silicon oxinitride layers (SiON), yttrium oxide layers (Y₂O₃), aluminum oxide layers (Al₂O₃), polymer layers and the like. These silicon photonics integrated circuit chips may be fabricated using conventional epitaxial growth, lithography and etching techniques. Production of these components may also incorporate ultrafast micromachining approaches in order to reduce manufacturing costs. A number of exemplary silicon photonic implementations of optical mode field converters that may be used in the optical communications systems according to embodiments of the present invention will now be discussed with reference to FIGS. 4A-H.

FIG. 4A is a schematic block diagram of an optical communications system 300 according to embodiments of the present invention that uses such a silicon photonic grating coupler based optical mode field converter. As shown in FIG. 4A, the optical communication system 300 takes an array of multi-mode optical fibers 310 that includes individual fibers 311-314 and couples signals carried by these multi-mode optical fibers via, for example, a photonic crystal waveguide onto an array of few-mode optical fibers 320 that includes individual optical fibers 321-324 using an array of four silicon photonic optical mode field converters 330. It will be appreciated that the array may be larger or smaller; only four components are shown in order to simplify the illustration. Each optical mode field converter that is included in the array 330 includes a respective silicon-based micro-mirror slab 341-344 and a respective grating coupler 351-354. Each silicon micro-mirror slab 341-344 may be used to change the direction of the optical signal that is emitted from the end of a corresponding one of the multi-mode optical fibers 311-314. Typically, the silicon micro-mirrors 341-344 may change the angle of the optical signal by about ninety degrees. The inclusion of the silicon micro-mirrors 341-344 allows the multi-mode optical fibers 311-314 to be generally aligned in the same plane with their corresponding few-mode optical fibers 321-324, which is typically the preferred way to connect two optical fibers, while still allowing each optical signal to enter its respective grating coupler 351-354 at the proper angle.

The silicon micro-mirror slabs 341-344 may be implemented using any appropriate semiconductor mirrors, and may include elements other than, or in addition to, silicon. It will also be appreciated that in other embodiments other types of mirrors may be used, as may other known elements for altering the angle of incidence of an optical signal. In some embodiments, each micro-mirror slab 341-344 may be implemented on the same integrated circuit chip as its corresponding grating coupler 351-354, while in other embodiments, the micro-mirror slabs 341-344 and the grating couplers 351-354 may be implemented as separate components.

The multi-mode optical fibers 311-314 may comprise, for example, conventional 850 nm multi-mode optical fibers having a core diameter of about 50 microns. The few-mode optical fibers may comprise conventional 1310 nm single-mode optical fibers having a core diameter of about 5 microns. It will be appreciated that in other embodiments some or all of the multi-mode optical fibers 311-314 may be replaced with optical transmitters that include, for example, a conventional multi-mode VCSEL, and that some or all of the few-mode optical fibers 321-324 may be replaced, for example, with optical receivers that include a small area photodetector.

The silicon photonic-based grating couplers 351-354 may be any appropriate silicon photonic grating coupler such as, for example, the broadband focusing grating couplers disclosed in U.S. Pat. No. 7,245,803 to Gunn III et al. entitled Optical Waveguide Grating Coupler, the entire contents of which are incorporated herein by reference. Other exemplary grating couplers are disclosed in F. Van Laera et al., “Compact Focusing Grating Couplers for Silicon-on-Insulator Integrated Circuits,” IEEE Photon. Tech. Lett., Vol. 19, page 1919 (2007), the entire contents of which are also incorporated herein by reference. According to embodiments of the present invention, these grating couplers may be adapted to be scaled up to receive a large area light field output such as the output of a conventional 850 nm multi-mode optical fiber. These grating couplers would then be used in different applications such as applications where the grating coupler receives a large area light field from, for example, a multi-mode VCSEL or a multi-mode optical fiber and reduces the size of this light field and transfers the light field to a few-mode optical fiber. Additional silicon photonic-based grating couplers that receive a vertically-coupled optical signal (i.e., with zero degree angle of incidence) or an optical signal with angle of incidence greater than zero degrees (e.g., an angle of incidence of about 10 degrees) are disclosed in a research paper by Taillaert et. al. published at J. Quantum Elec., Vol. 38, p. 949 (2002), a research paper by Bogaerts et. al. published in J. Light Tech., Vol. 23, p. 401 (2005) and a research paper by Roelkens et al. published in Opt. Lett., Vol. 32, p. 1495 (2007), the entire contents of each of which are incorporated herein by reference. The silicon photonic grating coupler array of FIG. 4A may be used, for example, to couple the output of a multi-mode MPO optical coupler onto a plurality of few-mode optical fibers.

It will also be appreciated that the silicon photonic grating coupler 351 of FIG. 4A (as well as grating couplers 352-354) acts as an optical connector that may be used to connect a first optical fiber 311 having a first cross-sectional area to a second optical fiber 321 that has a second cross-sectional area that is significantly smaller (e.g., ten times smaller) than the first cross-sectional area. In particular, the silicon-photonic-based grating coupler 351 is configured to receive a large area light field that is output from the first optical fiber 311 and converts this large area light field into a smaller area light field that is input to the second optical fiber 321. The mirror 341 is positioned to reflect the large area light field that is output from the first optical fiber 311 into the silicon photonic-based grating coupler 341. Notably, a portion of the first optical fiber 311 that is proximate the grating coupler 341 extends longitudinally in a first direction, and a portion of the second optical fiber 321 that is proximate the grating coupler 341 extends longitudinally in a second direction that is generally parallel to the first direction. This arrangement allows the optical connector to extend longitudinally in the same general direction as the first and second optical fibers 311, 321 that allows connection of the two optical fibers 311, 321 without having to significantly bend either optical fiber.

FIG. 4B schematically illustrates one possible implementation of the silicon photonic grating couplers 351-354 that are included in the optical communications system 300 of FIG. 4A. As shown in FIG. 4B, the large area light field from one of the multi-mode optical fibers 311-314 (the silicon micro-mirror slabs 341-344 of FIG. 4A are omitted in FIG. 4B to simplify the drawing) impinges on a grating structure 360 which changes the direction of the light field by ninety degrees and adiabatically reduces the area of the light field so that it may be optically coupled to one of the few mode optical fibers 321-324.

FIGS. 4C-4E are schematic diagrams that illustrate several exemplary silicon photonic tapered waveguides that may be used to implement the optical mode field converters that are included in the optical communications systems according to embodiments of the present invention,

In particular, FIG. 4C is a schematic block diagram of 3-dimensional tapered waveguide 400 that may be used, for example, to implement the optical mode field converters 130, 130′, 130″ in the optical communications system 100A-100E of FIGS. 2A-E. As shown in FIG. 4C, the tapered waveguide 400 may comprise a waveguide structure 410 that is grown or formed on an underlying substrate 420 such as, for example, a silicon substrate or a silicon-on-insulator substrate. A first end 412 of the waveguide structure 410 may have a large cross-sectional area, while a second end 416 of the waveguide structure 410 may have a small cross-sectional area. The waveguide structure 410 tapers in all three dimensions from the first end 412 to a middle section 414. As shown in inset 430 of FIG. 4C, a large area light field may be output from a multi-mode VCSEL or a multi-mode optical fiber which is input to the first end 412 of the waveguide structure 410. As shown in inset 432 of FIG. 4C, the large area light field spreads slightly at the interface between the source and the tapered waveguide 400, As shown in inset 434, the tapered waveguide structure 410 focuses the large area light field into a much smaller area light field that is output at the second end 416 of the tapered waveguide structure 410. This smaller area light field may then be coupled from the second end 416 of tapered waveguide 400 onto, for example, a few-mode optical fiber or to a photodetector of an optical receiver.

Examples of silicon photonic-based tapered waveguides that can be adapted to be scaled up for use in the optical communications systems according to embodiments of the present invention are disclosed, for example, in an article by B. Thomas Smith et al. entitled “Fundamental of Silicon Photonic Devices,” the entire content of which is incorporated herein by reference. It is believed that such waveguides, after up-scaling, will still be very small in size and exhibit a small insertion loss such as an insertion loss of less than 1 dB or even an insertion loss of less than 0.5 dB. Further examples of epitaxial grown silicon photonic-based tapered waveguides are disclosed in U.S. Pat. No. 6,956,983 to Morse entitled “Epitaxial Growth for Waveguide Tapering and an in an article by E. C. Nelson et al. entitled “Epitaxial Growth of Three-Dimensionally Architectured Optoelectronic Devices,” Nature Materials, Vol. 10, p. 676 (2011), the entire contents of each of which is incorporated herein by reference.

It will be appreciated that a wide variety of silicon photonic-based tapered waveguides may be used to form the optical mode field converters according to embodiments of the present invention. By way of example, FIG. 4D is a schematic illustration of a lithographically grown tapered waveguide 450 that has a three-dimensional taper that may be used instead of the tapered waveguide 400.

As another example, FIG. 4E illustrates an inverted tapered waveguide structure 500 that may be used to optically couple a large area light field from a light source 502 into a small area light field. As shown in the callouts 510 and 512 of FIG. 4E, the tapered waveguide structure 500 may comprise a semiconductor structure that includes a buried oxide layer 522 that is formed on an underlying silicon substrate or silicon layer 520. A tapered silicon waveguide 524 is formed on the buried oxide layer 522, and a silicon oxide layer 526 is deposited on the sidewalls and top surface of the silicon waveguide 524 via, for example, chemical vapor deposition or by chemical vapor deposition followed by lithography. The tapered silicon waveguide 524 may have any appropriate taper including, for example, a linear inverse taper, an exponential inverse taper or a quadratic inverse taper. The callouts 514 and 516 illustrate, respectively, the large area light field that is coupled to the inverse tapered waveguide structure 500 from the light source 502 and the small area light field that is coupled from the output of the inverse tapered waveguide structure 500. This smaller area light field may then be coupled onto, for example, a few-mode optical fiber or to a photodetector of an optical receiver.

FIGS. 4F-H schematically illustrate exemplary silicon photonic crystals that may be used to implement the optical mode field converters that are included in the optical communications systems according to embodiments of the present invention. Unlike silicon photonic waveguides, which typically are implemented as solid materials, photonic crystals refer to structures with two-dimensional or three-dimensional periodic arrays of holes, gratings or other structures with defects or surfaces that change the optical transmission characteristics or guiding of an optical signal.

FIG. 4F is a schematic perspective view of a three-dimensional silicon/silicon oxide photonic crystal 550 that is formed on an indium phosphide substrate 552. As shown in FIG. 4F, the indium phosphide substrate 552 includes a plurality of circular pits with a triangular lattice. A plurality of silicon layers 554 and silicon oxide layers 556 are formed on the indium phosphide substrate 552 and may automatically clone the three-dimensional structure of the indium phosphide substrate 552. The three dimensional structure of the photonic crystal structure 550 may be designed to focus a large area light field into a much smaller area light field.

FIG. 4G schematically illustrates a photonic crystal 560 which includes a line defect 562 that may be used to focus a large area light field that is incident on the crystal into a much smaller area light field. An example of this structure is discussed in Proc. of SPIE, Vol. 4870, p. 283 (2002). FIG. 4H schematically illustrates a photonic crystal tapered slab 570 which includes a plurality of honeycomb structures 572 that focus a large area light field into a smaller area light field. An example of this structure is discussed in Morandotti et al., Proc. SPIE, Vol. 5971 p. 59711J (2005). The entire contents of each of the above-referenced articles are incorporated herein by reference.

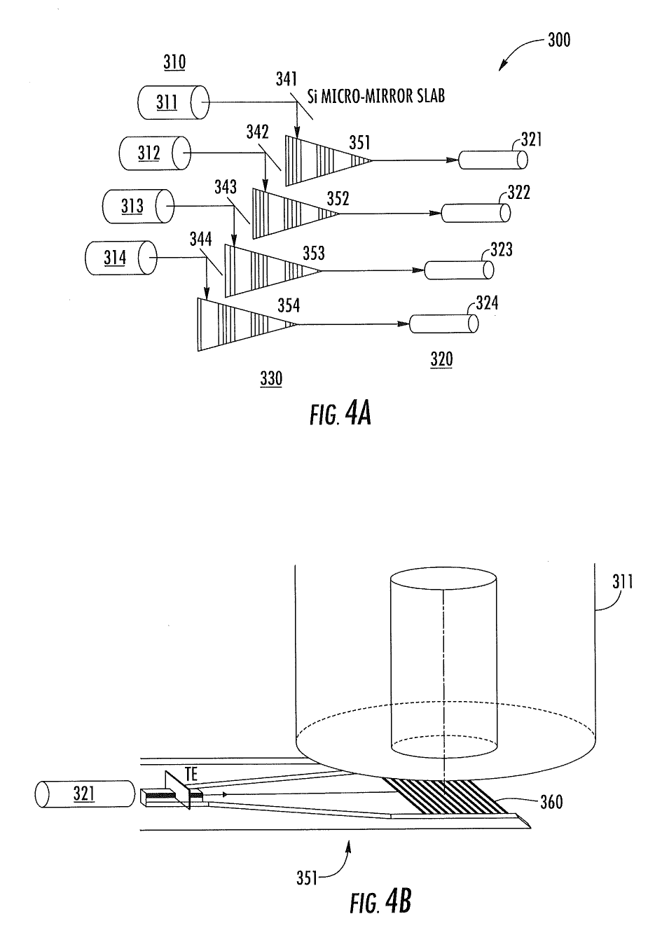

FIG. 5 is a block diagram of a fiber optic communications system 600 according to further embodiments of the present invention. As shown in FIG. 5, the fiber optic communications system 600 includes an optical transmitter 610. The optical transmitter 610 may have an optical transmission source 612 that is configured to transmit an optical signal 614 that has a first wavelength onto an optical transmission path 616 that is a multi-mode optical transmission path at the first wavelength. In some embodiments, the optical transmission source 612 may be a vertical-cavity-surface-emitting laser, and the optical signal having the first wavelength may comprise an 850 nm or a 1310 nm optical signal. The multi-mode optical transmission path 616 has a first cross-sectional area. Herein, the “cross-sectional area” of an optical fiber or other optical transmission path or medium refers to the area of a cross-section taken normal to the direction of travel of the optical signal through the optical transmission medium.

As is further shown in FIG. 5, the fiber optic communications system 600 further includes an optical mode field converter 630 that has an input 632 that is directly or indirectly optically coupled to the multi-mode optical transmission path 616. Additionally, an optical transmission medium 640 is coupled to an output 634 of the optical mode field converter 630. In some embodiments, the optical transmission medium 640 may be a first optical fiber that is a few-mode optical fiber for the optical signal 614 having the first wavelength. The optical transmission medium 640 has a second cross-sectional area that is smaller than the first cross-sectional area of the optical transmission path 616. The optical transmission medium 640 may be a few-mode transmission medium for the optical signal 614 having the first wavelength.

As is also shown in FIG. 5, in some embodiments, the fiber optic communications system 600 may also include a second optical fiber 620. The second optical fiber 620 may operate as a multi-mode optical fiber when passing the optical signal 614 having the first wavelength. The second (multi-mode) optical fiber 620 is optically coupled between the optical transmitter 612 and the optical mode field converter 630. The fiber optic communications system 600 may also include an optical receiver 650 that is optically coupled to the few-mode optical fiber 640. The optical receiver 650 may include a photo-detector 652. In some embodiments, the fiber optic communications system 600 may further include a second optical mode field converter 630′ that is optically coupled between the few-mode optical fiber 640 and the optical receiver 650. In some embodiments, the fiber optic communications system 600 may further include a third optical mode field converter 630″ that is optically coupled between the second optical mode field converter 630′ and the optical receiver 650. In some embodiments, the few-mode optical fiber 640 and at least one of the first and second optical mode field converters 630, 630′ may be integrally formed as part of the same fiber optic cable.

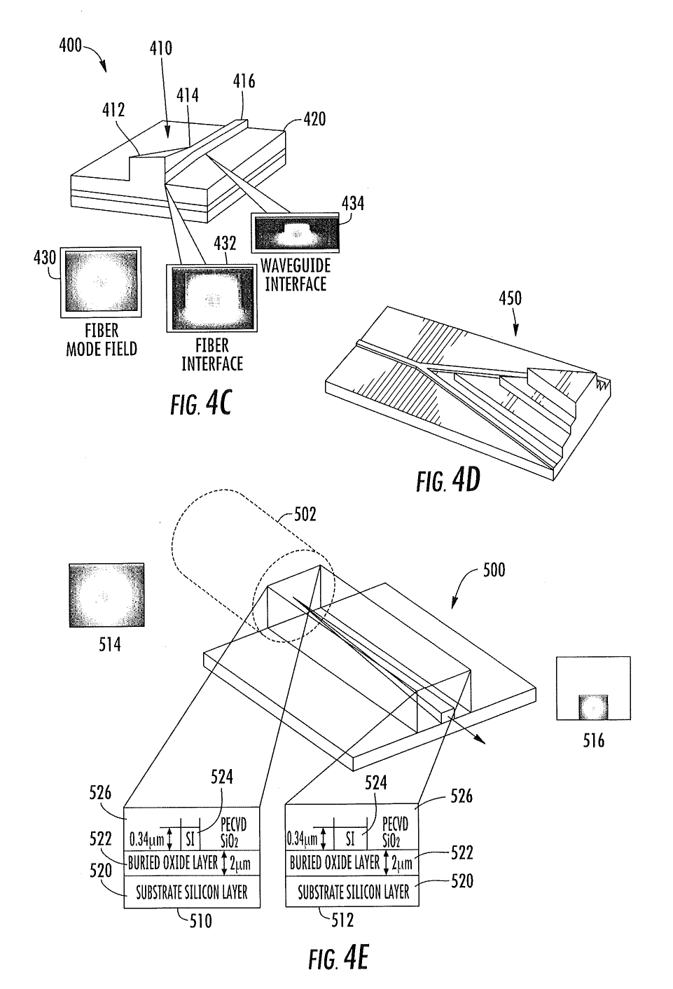

FIG. 6 is a flow chart that illustrates methods of optically transmitting data according to certain embodiments of the present invention. As shown in FIG. 6, operations may begin with the provision of an optical signal that has a first wavelength (block 660). The optical signal may comprise, for example, an 850 nm optical signal, and the optical transmission source that generates the optical signal may be a vertical-cavity-surface-emitting laser. In some embodiments, this optical signal may then be optically coupled to an optical fiber as a multi-mode optical signal (block 665). Regardless of whether or not the multi-mode optical fiber is provided, the optical signal may then be optically coupled as a multi-mode optical signal to an optical mode field converter or “OMFC” (block 670). The optical mode field converter is then used to convert the multi-mode optical signal into a few-mode optical signal (block 675).

Next, the few-mode optical signal is optically coupled onto an optical fiber that acts as a few-mode optical fiber when carrying signals having the first wavelength (block 680). The few-mode optical signal is then optically coupled from the few-mode optical fiber to an optical receiver (block 685). While not shown in FIG. 6, in some embodiments, the few-mode optical signal may be optically coupled to a second optical mode field converter, and in some cases, to a third optical mode field converter, before it is optically coupled to the optical receiver.

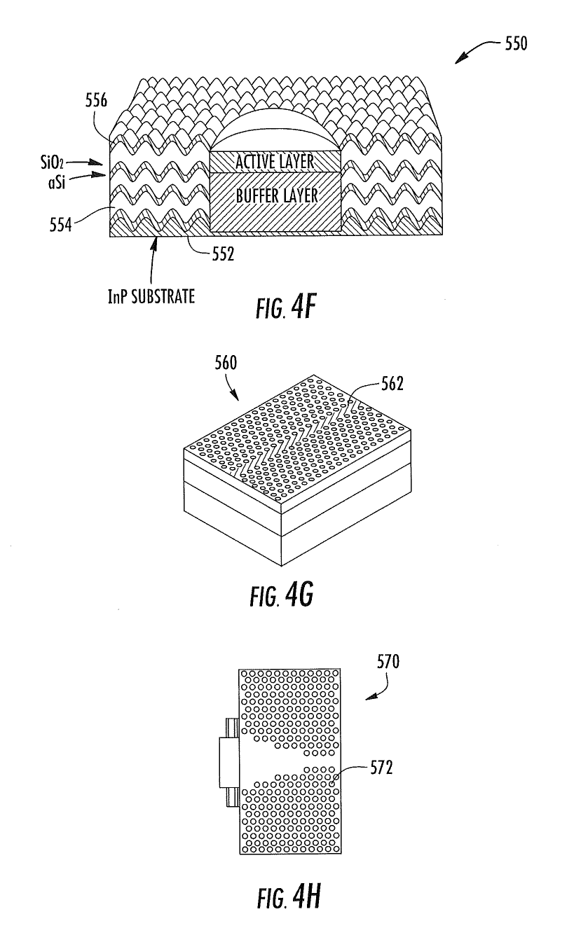

As discussed above, according to a further aspect of the present invention, optical mode field converters may be used to provide optical cables that are less susceptible to signal degradation due to dust particles. FIG. 7 is a schematic block diagram that illustrates a fiber optic cable 700 according to embodiments of the present invention that may support high data rates over extended distances while also being less susceptible to signal degradation due to dust particles.

As shown in FIG. 7, the optical cable 700 includes at least a first optical fiber 710 that is disposed within a cable jacket 720. One or more strength members 712 such as aramid yarns may also be provided within the jacket 720. A first optical mode field converter 730 is positioned directly adjacent to a first end of the optical fiber 710. The first optical mode field converter 730 may comprise, for example, a silicon photonic-based optical mode field converter that has a very small form factor. A first housing element 740 is provided that mounts the first optical mode field converter 730 in longitudinal alignment with the first end of the first optical fiber 710. A second optical mode field converter 750 may (optionally) be positioned directly adjacent to a second end of the optical fiber 710. The second optical mode field converter 750 may also comprise a silicon photonic-based optical mode field converter that has a very small form factor. A second housing element 760 may be provided that mounts the second optical mode field converter 750 in longitudinal alignment with the first end of the second optical fiber 710. The cable jacket 720 and the first and second housings 740, 760 may be formed at the factory as a single integrated cable unit 700. An exposed outer portion 732 of the first optical mode field converter 730 comprises a first input/output “port” for the cable 700, and an exposed outer portion 752 of the second optical mode field converter 750 comprises a second input/output “port” for the cable 700. Optical connectors may be used to connect each end of the fiber optic cable 700 to other fiber optic cables or to fiber optic apparatus.

In some embodiments, the first optical fiber 710 may be optically coupled to an optical transmitter that generates optical signals having a wavelength in the range of between about 850 nm and about 1310 nm that are output from the optical transmitter as multi-mode optical signals. The optical transmitter may comprise, for example, a multi-mode VCSEL. The first optical fiber 710 may have a cross-sectional area that is sized so that an optical signal that is generated by the optical transmitter will propagate as a few-mode optical signal on the first optical fiber 710. The first optical mode field converter 730 converts the multi-mode optical signal that is output by the optical transmitter into a few-mode optical signal. Likewise, the second optical mode field converter 750 will convert the few-mode optical signal that propagates across the first optical fiber 710 into a multi-mode optical signal. Accordingly, the exposed input/output ports 732, 752 will each have a large cross-sectional area for passing a multi-mode optical signal such as, for example, a cross-sectional area of at least 500 square microns. As a typical dust particle may have a cross-sectional area of on the order of one square micron, any dust particles that adhere to the exposed input/output ports 732, 752 will tend to only block a small percentage of the optical signal, and hence may not significantly degrade the optical signal that is passed over optical cable 700.

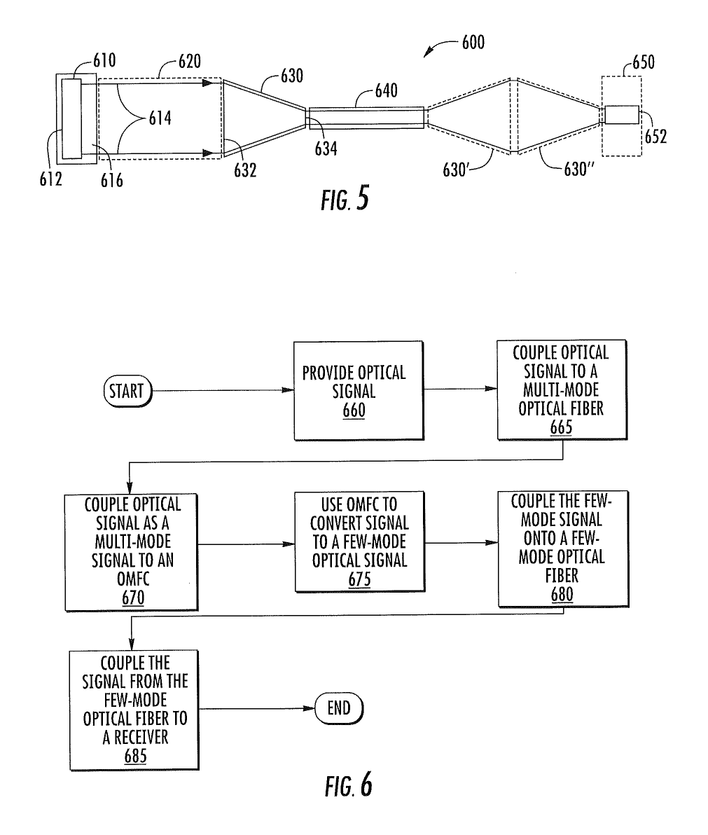

According to still further embodiments of the present invention, optical mode field converters may be used to take the optical signals carried by a linear array of optical fibers and to optically couple those optical signals onto a multi-core optical fiber. FIG. 8 is a schematic diagram that illustrates this approach. As shown in FIG. 8, a linear array of optical fibers 770 is provided. The linear array 770 may comprise, for example, an MPO fiber optic connector. A three-dimensional crystal photonic waveguide channel 775 may be optically coupled to the linear array of optical fibers 770. The three-dimensional photonic crystal waveguide channel 775 may take each of the light fields output by the optical fibers in the linear array 770 and route those light fields to respective ones of a plurality of cores 782 of a multi-core optical fiber 780. The photonic crystal waveguide channel 775 may have a small form-factor (e.g., it may be 1 centimeter in length), and can bend the light fields within this very small space at low loss in order to route the individual optical signals to the respective cores 782 of the multi-core optical fiber 780. In other embodiments (not shown), the optical fiber 780 may be replaced with a linear array of few-mode optical fibers so that the three-dimensional crystal photonic waveguide channel 775 may be used to optically couple a first linear array of multi-mode optical fibers such as the optical fibers of a multi-mode MPO connector to a second linear array of optical fibers such as the optical fibers of a single-mode MPO connector.

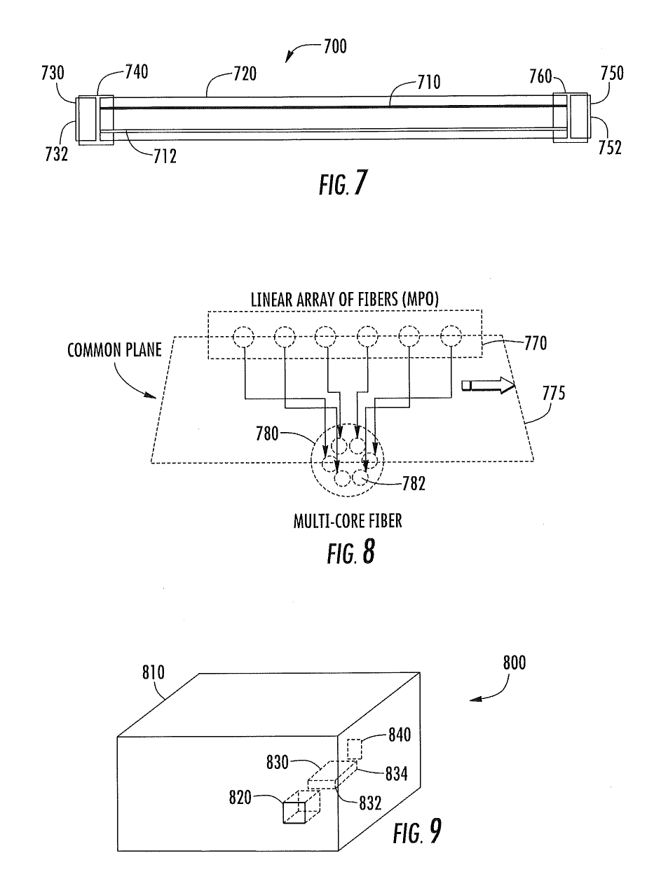

Pursuant to still further embodiments of the present invention, optical receiver units are provided that include an integrated optical mode field converter. These optical receivers may be used to convert a large area light field that is received, for example, from a multi-mode optical fiber, into a smaller area light field that is passed to a small area photodetector. FIG. 9 illustrates an exemplary embodiment of one such optical receiver 800.

As shown in FIG. 9, the optical receiver 800 includes a housing 810. The optical receiver 800 further includes a connector port 820 that is exposed through an opening in the housing 810. The connector port 820 is configured to receive an optical cable that includes at least a first optical fiber. The receiver 800 further includes an optical mode field converter 830 that is mounted within the housing 810. The optical mode field converter 830 has an input 832 that is optically coupled to the connector port 820 and that is configured to receive a large area light field from the first optical fiber of the optical cable. The optical receiver 800 further includes a photo-detector 840 that is optically coupled to a small area light field output 834 of the optical mode field converter 830.

A large area light source such as a connectorized optical cable that includes a multi-mode optical fiber may be plugged into the connector port 820. The optical mode field converter 830 compresses this large area light field into a small area light field. The photo-detector 840 may comprise a small area-photodetector that may have a photodetection surface that has an area that is approximately the area of the small area light field output from the optical mode field converter 830. Such small area photodetectors 840 may operate at higher data rates, and hence may provide for higher bandwidth communications.

The optical communications systems according to embodiments of the present invention also may be used to incorporate a wide variety of higher level functions in optical communications systems that are driven by a multi-mode VCSEL. By way of example, couplers (e.g., for extracting a small portion of an optical signal or for injecting a signal onto a fiber), WDM filters, dispersion compensators and other apparatus may be readily implemented in single-mode optical fiber communications systems. However, it may be difficult (and expensive) to implement such functionality in multi-mode fiber optic communications systems. As the optical communications systems according to certain embodiments of the present invention may transmit optical signals that are generated by a multi-mode VCSEL over a few-mode or single-mode optical fiber, the above-mentioned higher level functionality may be readily incorporated into the optical communications systems disclosed herein.

According to still further embodiments of the present invention, active optical cables may be provided that include an optical transmitter that includes a multi-mode VCSEL that is used to transmit an optical signal over a few-mode optical cable. As known to those of skill in the art, an active optical cable refers to an optical cable that is a sealed system that receives an electrical input signal and outputs an electrical output signal. The active optical cable includes an optical transmitter that is used to convert the electrical input signal into an optical signal, one or more optical cables over which the optical signal is transmitted, and an optical receiver that receives the optical signal and converts it to an electrical signal that is then output from the active optical cable. The active optical cables according to embodiments of the present invention could have, for example, the configuration of any of the optical communications systems 100A-100C that are described above with respect to FIGS. 2A-2C. In each case, the entire system depicted in the figure may be delivered as a sealed unit that further includes an input for an electrical signal (e.g., a pair of contact pads or other contacts that receive a differential signal) and an output for an electrical signal, which may be identical to the input.

The techniques according to embodiments of the present invention may also facilitate an orderly, gradual upgrade of existing multi-mode optical communications systems to single-mode optical communications systems. For example, as discussed above, by using optical mode field converters according to embodiments of the present invention at the outputs of the optical transceiver, an existing multi-mode system may be upgraded to use single-mode (or few-mode) optical fibers while keeping all of the multi-mode fiber apparatus in place. By replacing the multi-mode optical fibers with few-mode optical fibers, both the bandwidth and distance of the optical communications system may be increased. However, the optical communications system operator can wait until later to upgrade all of the optical apparatus (e.g., as such apparatus approaches its end of life), thereby allowing such operators to upgrade their communications systems in stages, which may be more cost efficient.

Thus, according to embodiments of the present invention, optical signals that are generated by inexpensive multi-mode VCSELs may be optically coupled to single-mode optical fibers. This may be used to greatly increase the bandwidth and/or distance of optical fiber communications systems, and do so at relatively low cost. Moreover, this can be done not only in new installations, but may also be performed as an upgrade to existing optical communications systems (where existing multi-mode optical fibers may be replaced with optical mode field converters and single-mode optical fibers), thereby allowing the continued use of installed optical apparatus while simultaneously significantly upgrading the capabilities of these already-installed optical communications systems. The optical communications systems according to embodiments of the present invention may use optical mode field converters that are developed, for example, by scaling up various silicon photonic structures such as tapered waveguides, photonic crystals and/or grating couplers to so that they will convert multi-mode signals at 850 or 1310 nm into few-mode optical signals, and vice versa. These silicon photonic structures may be small devices that may be readily and inexpensively mass-produced.

Embodiments of the present invention have been described above with reference to the accompanying drawings, in which embodiments of the invention are shown. This invention may, however, be embodied in many different forms and should not be construed as limited to the embodiments set forth above. Rather, these embodiments are provided so that this disclosure will be thorough and complete, and will fully convey the scope of the invention to those skilled in the art.

It will be understood that, although the terms first, second, etc. may be used above and in the claims that follow to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

All embodiments can be combined in any way and/or combination.

Many variations and modifications can be made to the preferred embodiments without substantially departing from the principles of the present invention. All such variations and modifications are intended to be included herein within the scope of the present invention, as set forth in the following claims.

1. A fiber optic communications system, comprising:
an optical transmitter that includes an optical transmission source that is configured to transmit an optical signal having a first wavelength onto an optical transmission path that has a first cross-sectional area and is a multi-mode optical transmission path at the first wavelength;
an optical mode field converter that is optically coupled to the multi-mode optical transmission path; and
a fiber optic transmission medium that is optically coupled to the optical mode field converter, the fiber optic transmission medium having a second cross-sectional area that is smaller than the first cross-sectional area, the fiber optic transmission medium comprising a few-mode transmission medium for the optical signal having the first wavelength.

2. The fiber optic communications system of claim 1, wherein the optical transmission source comprises a vertical-cavity-surface-emitting laser.

3. The fiber optic communications system of claim 2, wherein the fiber optic transmission medium comprises a first optical fiber that is a few-mode optical fiber for the optical signal having the first wavelength.

4. The fiber optic communications system of claim 3, wherein the fiber optic transmission medium comprises a first optical fiber that is a single-mode optical fiber for the optical signal having the first wavelength.

5. The fiber optic communications system of claim 3, further comprising a second optical fiber that is a multi-mode optical fiber for the optical signal having the first wavelength, wherein the multi-mode optical fiber is optically coupled between the optical transmitter and the optical mode field converter.

6. The fiber optic communications system of claim 3, wherein the first wavelength is within the range of about 600 nm to about 1550 nm.

7. The fiber optic communications system of claim 3, further comprising an optical receiver optically coupled to the few-mode optical fiber.

8. The fiber optic communications system of claim 3, wherein the optical mode field converter comprises a first optical mode field converter, the system further comprising a second optical mode field converter that is optically coupled between the few-mode optical fiber and the optical receiver.

9. The fiber optic communications system of claim 8, further comprising a third optical mode field converter that is optically coupled between the second optical mode field converter and the optical receiver.

10. The fiber optic communications system of claim 8, wherein the few-mode optical fiber and at least one of the first and second optical mode field converters comprise an integral structure.

11. A method of optically transmitting data, the method comprising:
providing an optical signal having a first wavelength;
coupling the optical signal as a multi-mode optical signal to an optical mode field converter;
using the optical mode field converter to convert the multi-mode optical signal into a few-mode optical signal; and
coupling the few-mode optical signal onto an optical fiber that acts as a few-mode optical fiber when carrying signals having the first wavelength.

12. The method of claim 11, wherein the optical signal comprises an 850 nm optical signal, and wherein a vertical-cavity-surface-emitting laser is used as an optical transmitter to provide the optical signal having the first wavelength.

13. The method of claim 12, the method further comprising coupling the multi-mode optical signal from the optical transmitter before coupling the multi-mode optical signal to the optical mode field converter.

14. The method of claim 12, the method further comprising coupling the few-mode optical signal from the few-mode optical fiber to an optical receiver.

15. The method of claim 14, wherein coupling the few-mode optical signal from the few-mode optical fiber to the optical receiver comprises coupling the few-mode optical signal from the few-mode optical fiber to a second optical mode field converter that converts the few-mode optical signal into a second multi-mode optical signal and then coupling the second multi-mode optical signal from the second optical mode field converter to the optical receiver.

16. A method of transmitting an optical signal through an optical connector, the method comprising:
transmitting the optical signal as a first few-mode optical signal along an optical transmission medium;
converting the first few-mode optical signal to a multi-mode optical signal; then
transmitting the multi-mode optical signal through the optical connector; and then
converting the multi-mode optical signal into a second few mode optical signal.

17. The method of claim 16, wherein a first optical mode field converter is used to convert the first few-mode optical signal to the multi-mode optical signal, and wherein a second optical mode field converter is used to convert the multi-mode optical signal to the second few-mode optical signal.

18. The method of claim 17, wherein the first optical mode field converter and the second optical mode field converter are each directly connected to the optical connector.

19. The method of claim 17, wherein the optical signal has a first wavelength of about 600 nm or of about 1550 nm.

20.-34. (canceled)

35. The fiber optic communications system of claim 1, wherein the optical mode field converter comprises a silicon photonic-based optical mode field converter.

36. The method of claim 11, wherein the optical mode field converter comprises a silicon photonic-based optical mode field converter.

37. The method of claim 17, wherein at least one of the first optical mode field converter or the second optical mode field converter comprises a silicon photonic-based optical mode field converter.
